(19) United States
(12) Patent Application Publication
(10) Pub. No.: US 2004/0005206 A1
(43) Pub. Date: Jan. 8, 2004

(54) Steel bar joint

(75) Inventor: Chao-Hsiung Lin, Tao Ywan Hsien (TW)

Correspondence Address: TROXELL LAW OFFICE PLLC, SUITE 1404, 5205 LEESBURG PIKE, FALLS CHURCH, VA, 22041, US

(73) Assignee: Joint System Couplers Co., Ltd.

(21) Appl. No.: 10/188,758

(22) Filed: Jul. 5, 2002

(51) Int. Cl. F16B 39/02

(52) U.S. Cl. 411/325

(57) ABSTRACT

A steel bar joint includes at least one internally threaded sleeve and at least one externally threaded bolt that are screwed together to serially connect two steel bars to each other. The bolt is provided on at least one free end surface with equally spaced radial splits, and a spike dowel is located in an inner bottom of the sleeve to align a pointed bar of the spike dowel with a convergent hole of the radial splits on the free end surface of the bolt. When the bolt is fully screwed to the inner bottom of the sleeve, the pointed bar of the spike dowel is forced into the convergent hole on the bolt to expand open the radial splits, so that the free end of the bolt is tightly located in the sleeve to effectively prevent the whole steel bar joint from shaking or loosening.

### FIELD OF THE INVENTION

The present invention relates to an improvement of steel bar joint, and more particularly to a steel bar joint consisting of at least two mutually screwed sleeve and bolt, wherein the bolt has a free end provided with external threads and a free end surface provided with equally spaced radial splits, and the sleeve is provided with internal threads and has a spike dowel located therein. When the bolt is fully screwed into the sleeve, a pointed bar of the spike dowel is forced into a convergent hole of the radial splits to expand the free end of the bolt, enabling the bolt to tightly locate in the sleeve for the whole steel bar joint to function more stably.

### BACKGROUND OF THE INVENTION

In current building construction, steel bar joints have been widely used to connect two steel bars end to end. There are various differently designed steel bar joints available in the markets. One of these currently available steel bar joints includes one or more internally threaded sleeves and externally threaded bolts that are screwed together to serially connect two steel bars to each other. In using this type of steel bar joint to serially connect two steel bars, either the sleeves or the bolts, or a combination of them, are fixedly connected to two opposite ends of the two steel bars. The sleeves may have either a straight or a backward tapered inner wall surface on which internal threads are provided, and the bolts may have either a straight or a forward tapered outer wall surface on which external threads are provided. Since the internal and the external threads provided on the sleeves and the bolts, respectively, are not so precisely formed, the sleeves and the bolts are not in close contact with each other and there is clearance existing between them to result in shaking or loosened and accordingly unstable steel bar joints. Such unstable steel bar joints have adverse influences on the quality and progress of the whole building construction and therefore require improvements.

### SUMMARY OF THE INVENTION

A primary object of the present invention is to provide an improvement of steel bar joint. The steel bar joint includes at least one internally threaded sleeve and at least one externally threaded bolt that are screwed together to serially connect two steel bars to each other. The bolt is provided on at least one free end surface with equally spaced radial splits, and a spike dowel is located in an inner bottom of the sleeve to align a pointed bar of the spike dowel with a convergent hole of the radial splits on the free end surface of the bolt. Whereby when the bolt is fully screwed to the inner bottom of the sleeve, the pointed bar of the spike dowel is forced into the convergent hole on the bolt to expand open the radial splits, so that the free end of the bolt is tightly located in the sleeve to effectively prevent the whole steel bar joint from shaking or loosening.

Another object of the present invention is to provide an improvement of steel bar joint. The steel bar joint includes at least one internally threaded sleeve and at least one externally threaded bolt that are screwed together to serially connect two steel bars to each other. It is possible to first connect rear ends of two sleeves to two steel bars and then screw front ends of the sleeves to two free ends of one bolt, or to first connect rear ends of two bolts to two steel bars and then screw free ends of the bolts to two ends of one sleeve, or to first connect rear ends of a sleeve and a bolt to two steel bars and then screw free ends of the sleeve and the bolt together. Wherein, the sleeves may have either a straight or a backward tapered inner wall surface on which internal threads are provided, and the bolts may have either a straight or a forward tapered outer wall surface on which external threads are provided.

A further object of the present invention is to provide an improvement of steel bar joint. The steel bar joint includes at least one internally threaded sleeve and at least one externally threaded bolt that are screwed together to serially connect two steel bars to each other. The bolt is provided on at least one free end surface with equally spaced radial splits, and a spike dowel is located in an inner bottom of the sleeve to align a pointed bar of the spike dowel with a convergent hole of the radial splits on the free end surface of the bolt. Wherein, the spike dowel may be a separate member from the sleeve to have a pointed bar and a flat seat, or an integral part of the inner bottom of the sleeve to have only the pointed bar. In either case, when the bolt is fully screwed to the inner bottom of the sleeve, the pointed bar of the spike dowel is forced into the convergent hole of the radial splits on the bolt to expand open the free end of the bolt.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded sectional view of a steel bar joint according to a first embodiment of the present invention;

FIG. 1A an assembled view of FIG. 1;

FIG. 2 is an exploded sectional view of a steel bar joint according to a second embodiment of the present invention;

FIG. 2A an assembled view of FIG. 2;

FIG. 3 is an exploded sectional view of a steel bar joint according to a third embodiment of the present invention;

FIG. 3A an assembled view of FIG. 3;

FIG. 4 is an exploded perspective view of the steel bar joint of FIG. 3;

FIG. 5 is an assembled view of FIG. 4;

FIG. 6 is an exploded sectional view of a steel bar joint according to a fourth embodiment of the present invention;

FIG. 6A an assembled view of FIG. 6;

FIG. 7 is an exploded sectional view of a steel bar joint according to a fifth embodiment of the present invention;

FIG. 7A an assembled view of FIG. 7;

FIG. 8 is an exploded sectional view of a steel bar joint according to a sixth embodiment of the present invention;

FIG. 8A an assembled view of FIG. 8;

FIG. 9 is an exploded sectional view of a steel bar joint according to a seventh embodiment of the present invention; FIG. 9A an assembled view of FIG. 9;

FIG. 10 is an exploded perspective view of a steel bar joint according to an eighth embodiment of the present invention;

FIG. 10A is an assembled view of FIG. 10;

FIG. 10B is an exploded sectional view of the steel bar joint of FIG. 10;

FIG. 10C is an assembled view of FIG. 10B;

FIG. 11 is an exploded perspective view of a steel bar joint according to a ninth embodiment of the present invention;

FIG. 11A is a sectional view of FIG. 11; and

FIG. 11B is an exploded sectional view of a steel bar joint according to a tenth embodiment of the present invention.

### DETAILED DESCRIPTION OF THE PREFERRED EMBODIMENTS

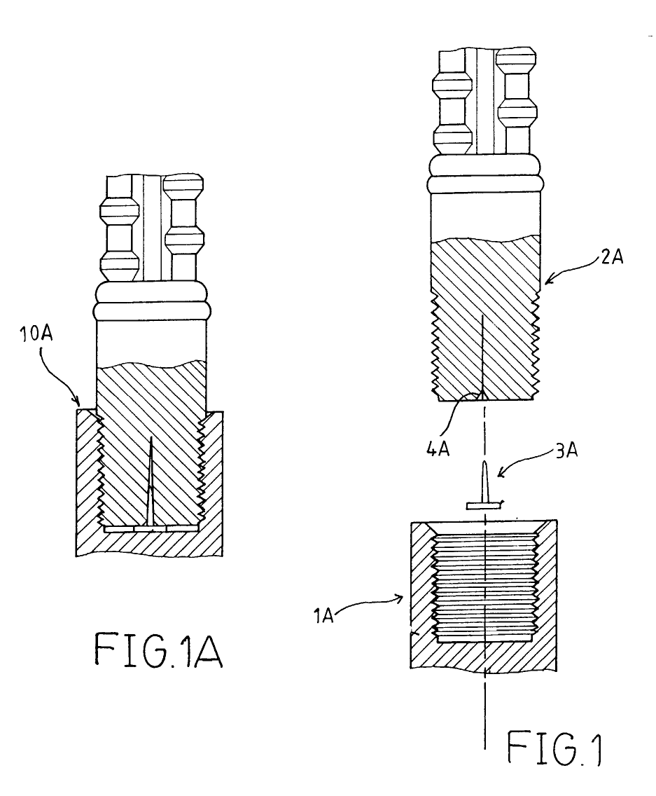

Please refer to FIGS. 1 and 1A that are exploded and assembled sectional views, respectively, of a steel bar joint 10A according to a first embodiment of the present invention. The steel bar joint 10A includes a sleeve 1A and a bolt 2A for separately connecting to two opposite ends of two steel bars to be serially joined together. The sleeve 1A and the bolt 2A may be connected to the steel bars in any acceptable manner, such as a friction welding as shown in the illustrated drawings or simply a general welding. The sleeve 1A has a straight inner wall surface on which internal threads are provided, and the bolt 2A has a free end having a straight outer wall surface on which external threads corresponding to the internal threads of the sleeve 1A are provided. The bolt 2A is provided at an end surface of the free end with a plurality of angularly equally spaced radial splits 4A. A spike dowel 3A, which is a separate member, including a pointed bar centered at one side of a flat seat is provided for use with the steel bar joint 10A. When the bolt 2A is fully screwed to an inner bottom of the sleeve 1A with the spike dowel 3A positioned between the bolt 2A and the sleeve 1A, the pointed bar of the spike dowel 3A is forced into a convergent center hole of the radial splits 4A to expand open the free end of the bolt 2A, enabling the bolt 2A to stably locate in the sleeve 1A without loosely shaking therein. The steel bar joint 10A therefore firmly joins two steel bars end to end.

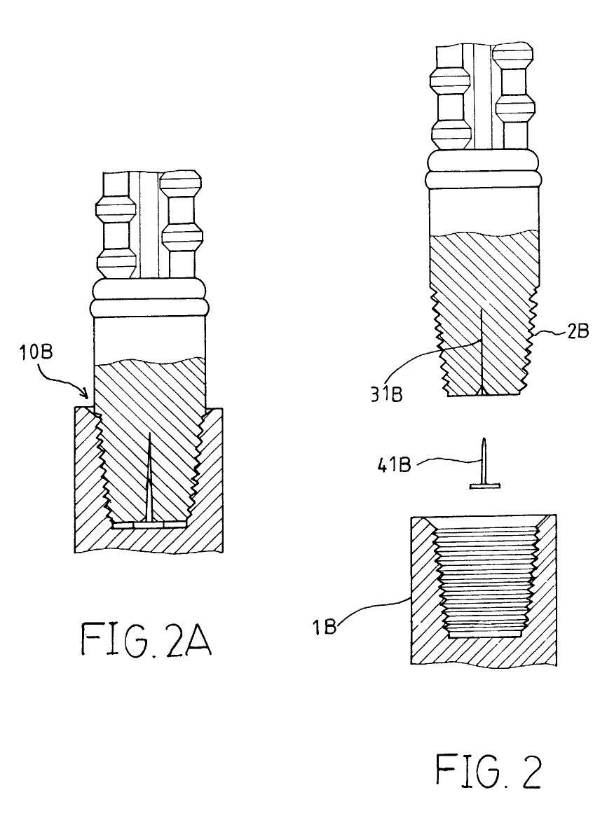

FIGS. 2 and 2A are exploded and assembled sectional views, respectively, of a steel bar joint 10B according to a second embodiment of the present invention. The steel bar joint 10B is structurally and functionally similar to the steel bar joint 10A and includes a sleeve 1B, a bolt 2B having radial splits 31B provided at a free end surface thereof, and a separate spike dowel 41B. The steel bar joint 10B is different from the steel bar joint 10A in that the sleeve 1B has a backward tapered and internally threaded inner wall surface, and that the bolt 2B has a forward tapered and externally threaded outer wall surface.

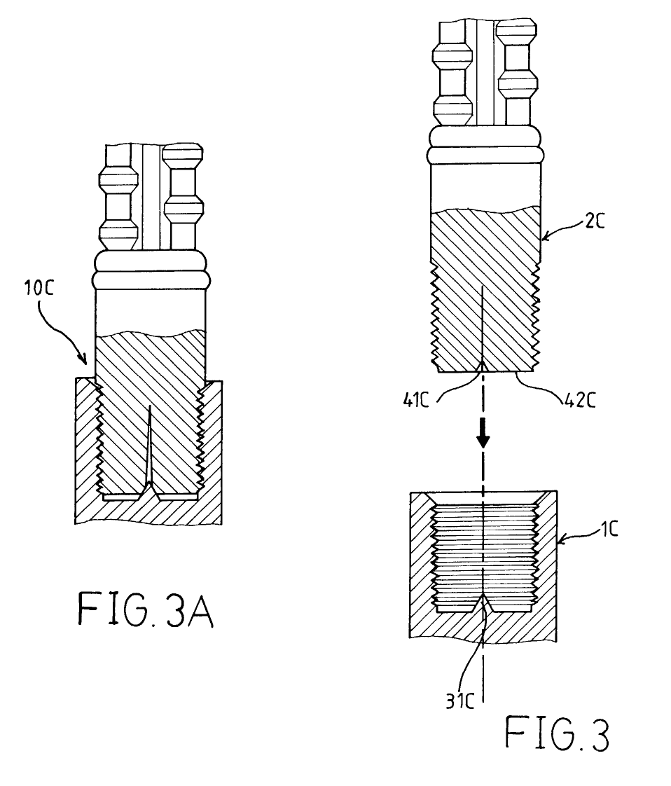

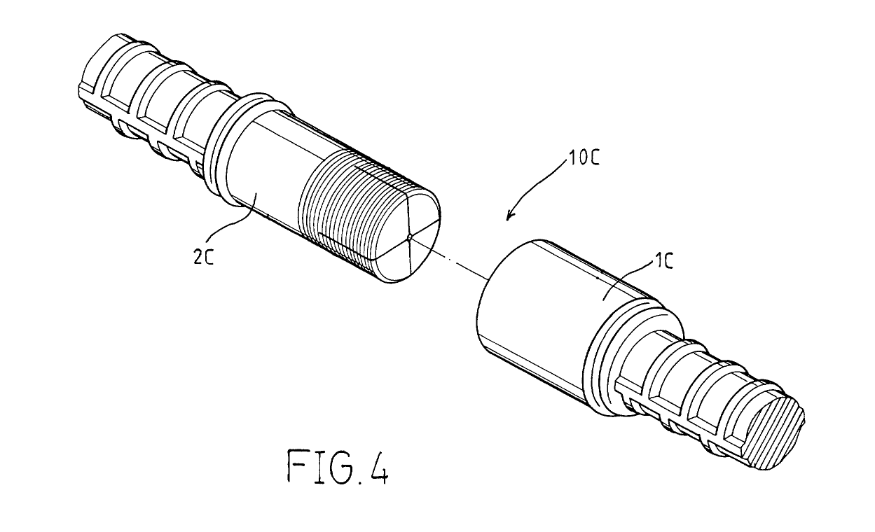

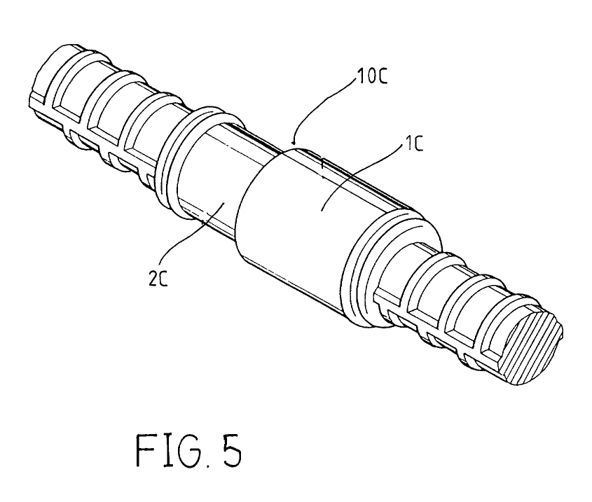

FIGS. 3 and 3A are exploded and assembled sectional views, respectively, of a steel bar joint 10C according to a third embodiment of the present invention, and FIGS. 4 and 5 are exploded and assembled perspective views, respectively, of the steel bar joint 10C. The steel bar joint 10C includes a sleeve 1C and a bolt 2C for separately connecting to two opposite ends of two steel bars to be serially joined together. The sleeve 1C has a straight inner wall surface on which internal threads are provided, and the bolt 2C has a free end having a straight outer wall surface on which external threads corresponding to the internal threads of the sleeve 1C are provided. The bolt 2C is provided at an end surface of the free end with a plurality of angularly equally spaced radial splits 42C that converge at a center hole 41C. An inner bottom center of the sleeve 1C has an integrally formed spike dowel 31C. When the bolt 2C is fully screwed to the inner bottom of the sleeve 1C, a pointed bar of the spike dowel 31C is forced into the convergent center hole 41C of the radial splits 42C at the free end surface of the bolt 2C, enabling the free end of the bolt 2C to expand open and stably locate in the sleeve 1C.

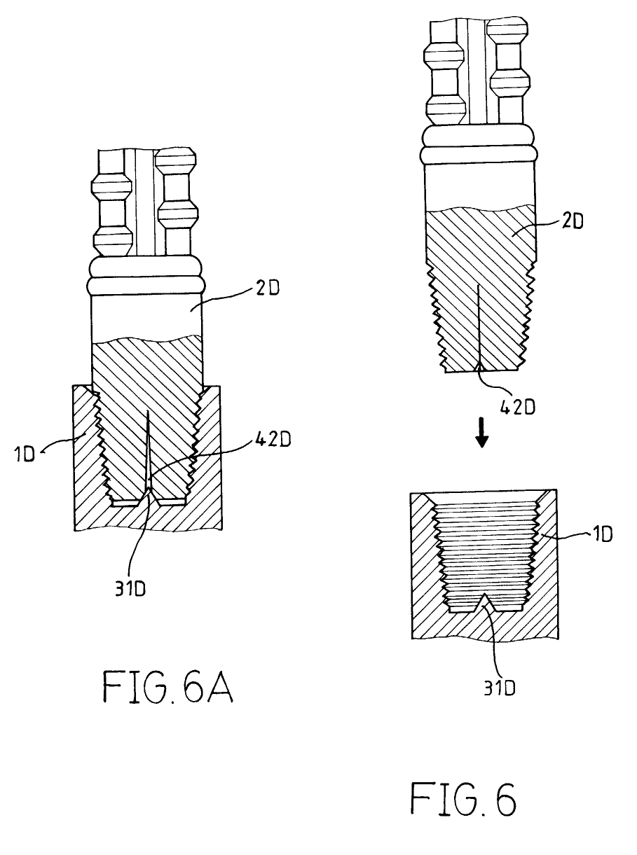

FIGS. 6 and 6A are exploded and assembled sectional views, respectively, of a steel bar joint according to a fourth embodiment of the present invention. The steel bar joint of this fourth embodiment includes a sleeve 1D and a bolt 2D for separately connecting to two opposite ends of two steel bars to be serially joined together. The sleeve 1D has a backward tapered inner wall surface on which internal threads are provided, and the bolt 2D has a free end having a forward tapered outer wall surface on which external threads corresponding to the internal threads of the sleeve 1D are provided. The bolt 2D is provided at an end surface of the free end with a plurality of angularly equally spaced radial splits 42D. An inner bottom center of the sleeve 1D has an integrally formed spike dowel 31D. When the bolt 2D is fully screwed to the inner bottom of the sleeve 1D, a pointed bar of the spike dowel 31D is forced into a convergent center hole of the radial splits 42D at the free end surface of the bolt 2D, enabling the free end of the bolt 2D to expand open and stably locate in the sleeve 1D.

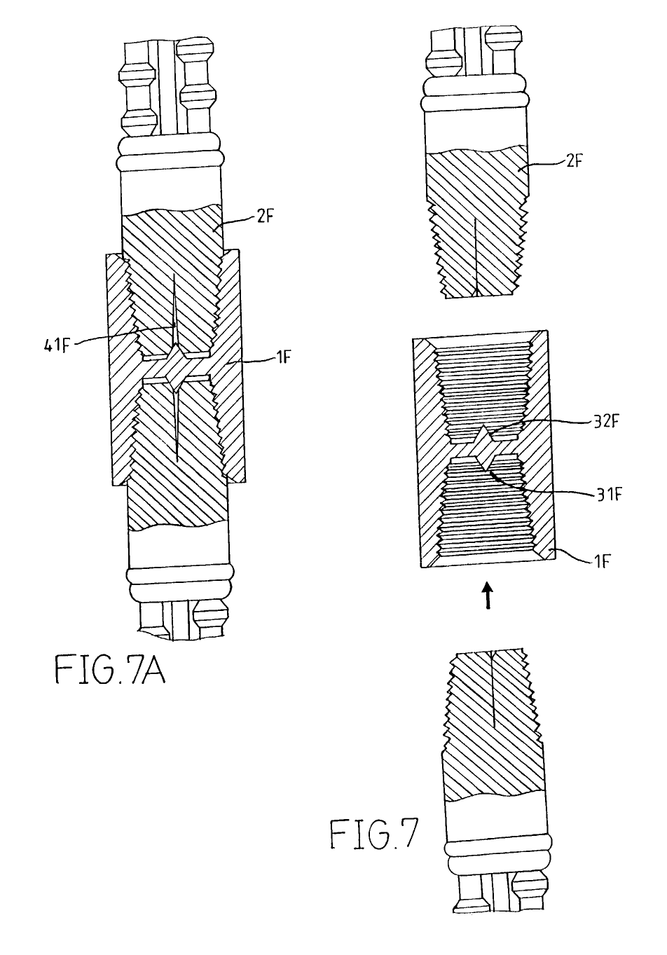

Please refer to FIGS. 7 and 7A that are exploded and assembled sectional views, respectively, of a steel bar joint according to a fifth embodiment of the present invention. The steel bar joint of this fifth embodiment includes a sleeve 1F and two bolts 2F. The sleeve 1F defines at two ends two openings having inward tapered and internally threaded inner wall surfaces, and each bolt 2F has a free end having a forward tapered and externally threaded outer wall surface. The bolts 2F are provided at respective end surfaces of the free ends with a plurality of angularly equally spaced radial splits 41F, and inner bottom centers of the two end openings of the sleeve 1F separately have two integrally formed spike dowels 31F, 32F. Rear ends of the two bolts 2F are separately connected to two opposite ends of two steel bars to be serially joined together, and free ends of the two bolts 2F are separately screwed into the two internally threaded end openings of the sleeve 1F. When the two bolts 2F are fully screwed into the two end openings of the sleeve 1F, pointed bars of the two spike dowels 31F, 32F are separately forced into two convergent center holes of the radial splits 42F at the two free end surfaces of the bolts 2F, enabling the free ends of the two bolts 2F to expand open and stably locate in the two end openings of the sleeve 1F.

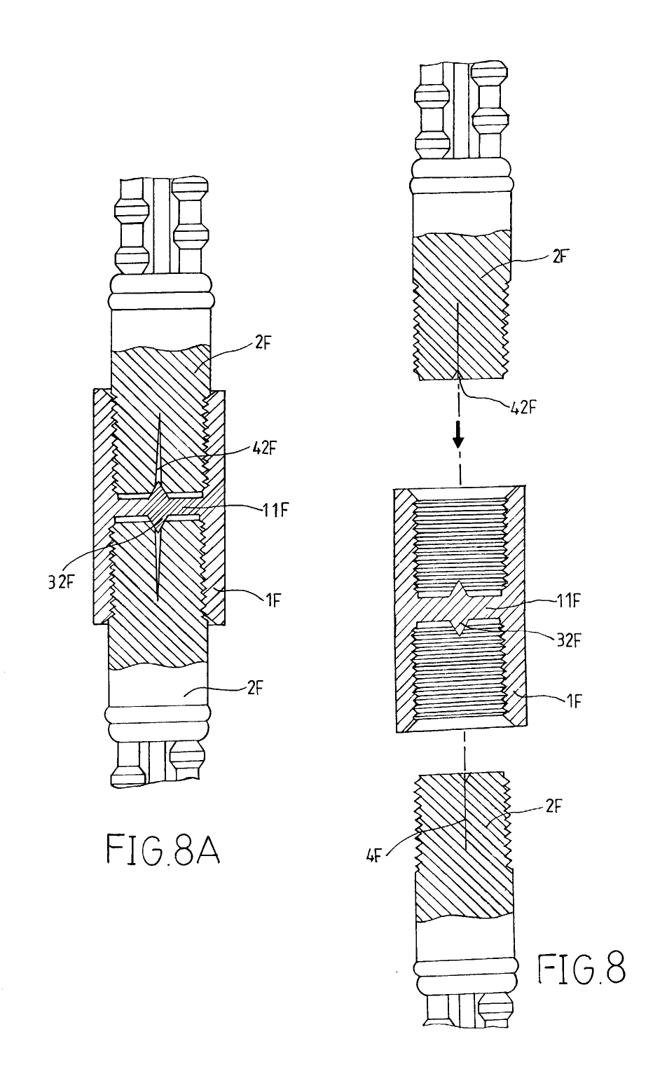

Please refer to FIGS. 8 and 8A that are exploded and assembled sectional views, respectively, of a steel bar joint according to a sixth embodiment of the present invention. The steel bar joint of this sixth embodiment is structurally and functionally similar to the steel bar joint illustrated in FIGS. 7 and 7A, except that the two end openings of the sleeve 1F and the free ends of the bolts 2F of the steel bar joint of FIG. 8 have straight and threaded inner and outer wall surfaces, respectively. And, two spike dowels 31F, 32F are separately centered at two sides of an intermediate partition 11F between the two end openings of the sleeve 1F.

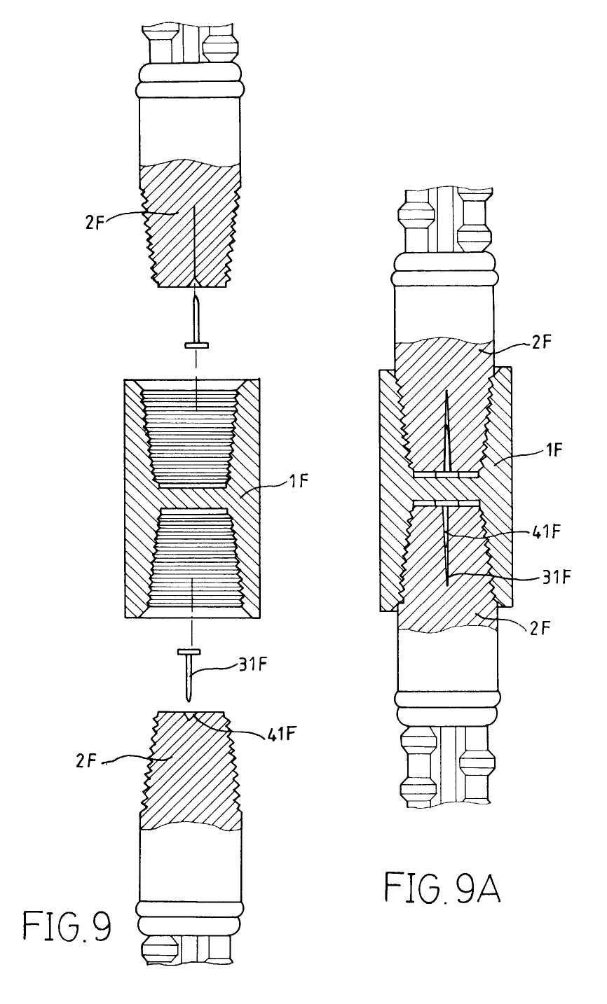

FIGS. 9 and 9A are exploded and assembled sectional views, respectively, of a steel bar joint according to a seventh embodiment of the present invention. The steel bar joint of this seventh embodiment is structurally and functionally similar to the steel bar joint illustrated in FIGS. 7 and 7A, except that the spike dowels 31F, 32F are two separate members instead of being integrally forming at bottom centers of the two end openings of the sleeve 1F.

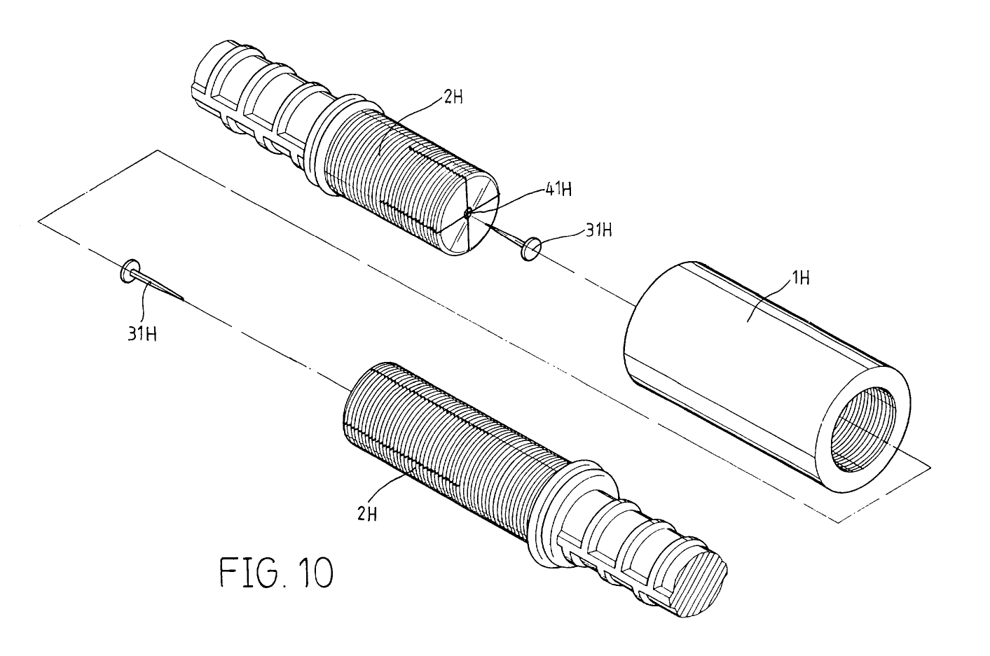

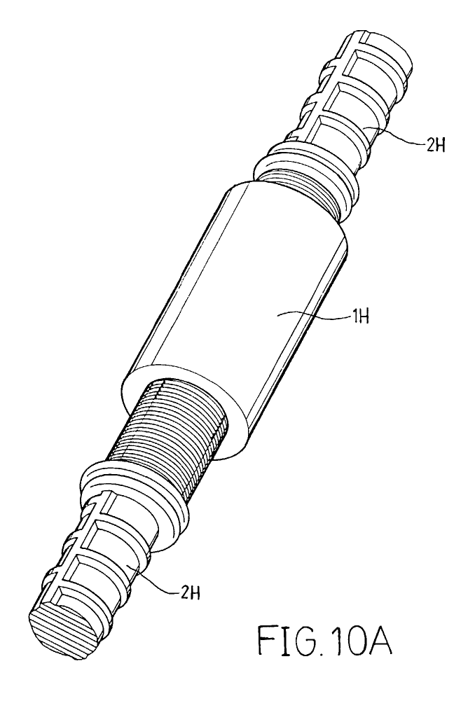

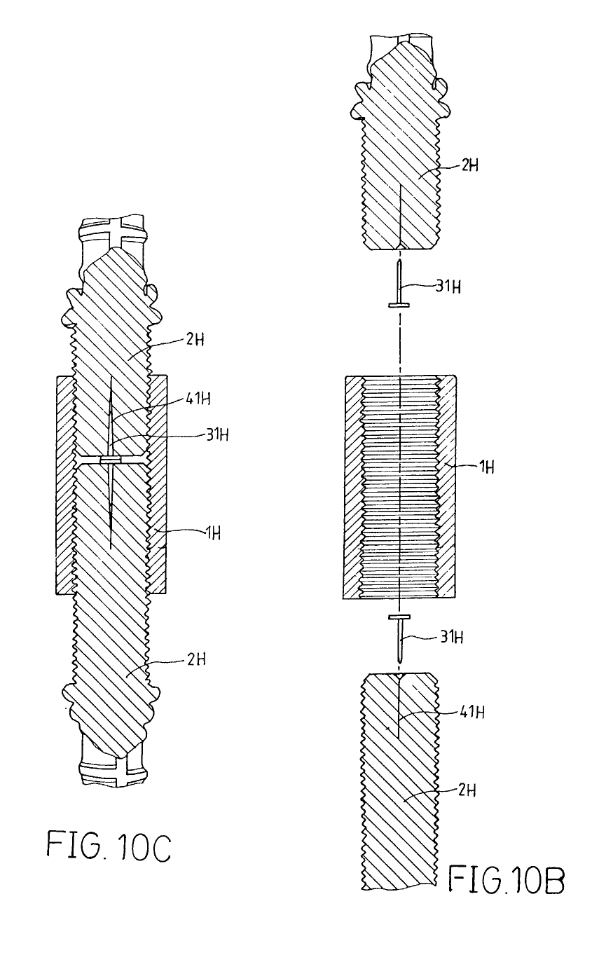

Please refer to FIGS. 10 and 10A that are exploded and assembled perspective views, respectively, of a steel bar joint according to an eighth embodiment of the present invention, and to FIGS. 10B and 10C that are exploded and assembled sectional views, respectively, of this embodiment. The steel bar joint of this eighth embodiment is structurally and functionally similar to the steel bar joint illustrated in FIGS. 9 and 9A and includes two bolts 2H for separately connecting at rear ends to two opposite ends of two steel bars to be serially connected to each other, and a sleeve 1H defining two internally threaded end openings for engaging with externally threaded free ends of the two bolts 2H. The two bolts 2H are provided at respective free end surfaces with a plurality of radial splits 41H. The steel bar joint shown in FIG. 10 is different from the steel bar joint shown in FIGS. 9 and 9A in that the sleeve 1H defines a through opening therein and the intermediate partition 11F is omitted, that the through opening of the sleeve 1H has a straight and internally threaded inner wall surface while the two bolts 2H have free ends having straight and externally threaded outer wall surface, and that two separate spike dowels 31H are provided for use with the two bolts 2H. When the free ends of the two bolts 2H are separately fully screwed into two ends of the internally threaded through opening of the sleeve 1H with pointed bars of the two spike dowels 31H positioned in convergent holes of the radial splits 41H at the free end surfaces of the bolts 2H, flat seats of the two spike dowels 31H are caused to tightly abut against each other in the sleeve 1H and the pointed bars of the spike dowels 31H are forced into the convergent center holes of the radial splits 41H to expand open the free ends of the two bolts 2H, enabling the latter to firmly locate in two ends of the sleeve 1H.

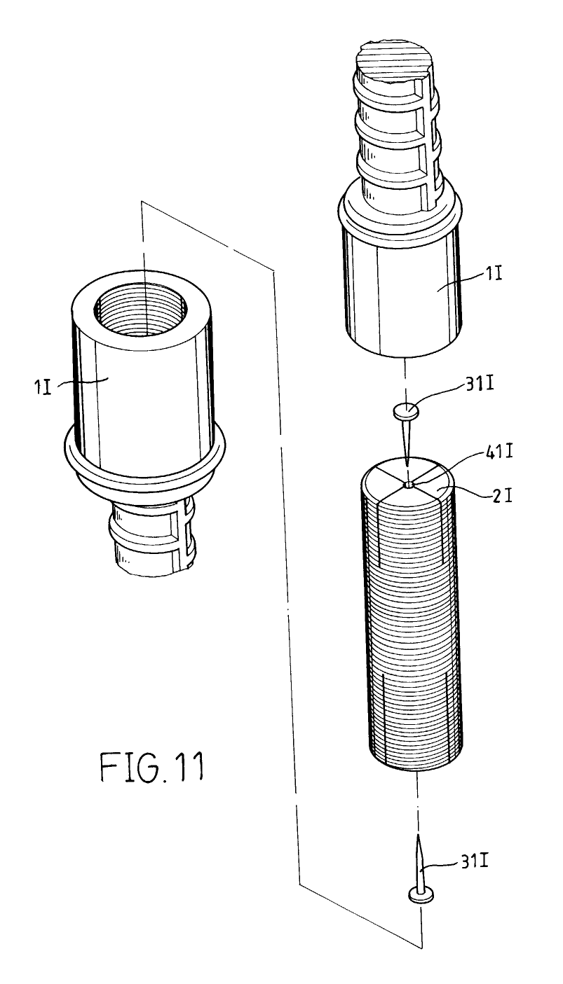

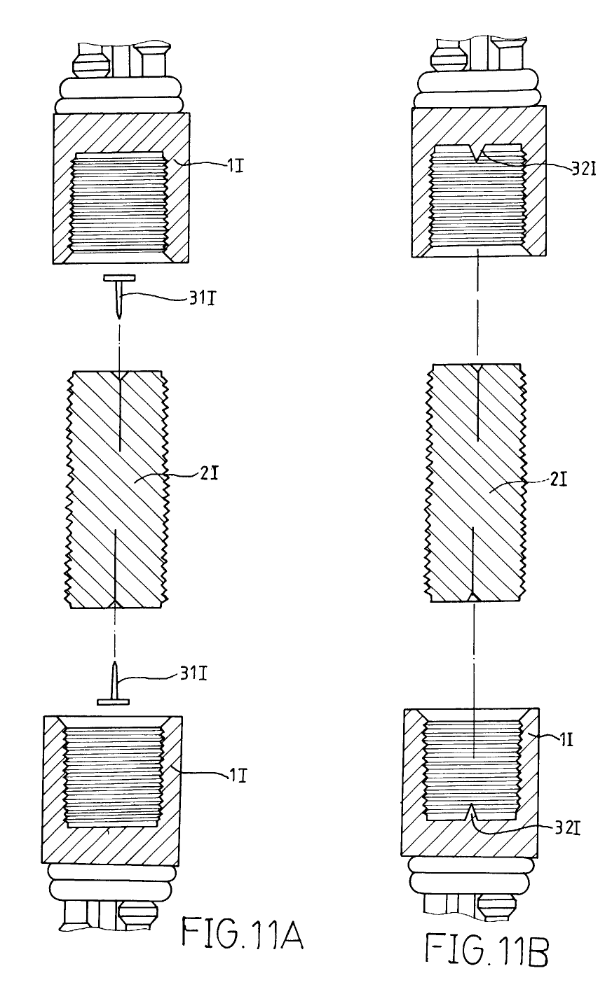

FIGS. 11 and 11A are exploded perspective and sectional views, respectively, of a steel bar joint according to a ninth embodiment of the present invention. The steel bar joint of this ninth embodiment includes two sleeves 1I for separately connecting at rear ends to two opposite ends of two steel bars to be serially connected to each other, and a bolt 2I having a straight and externally threaded outer wall surface. Each sleeve 1I defines at a free end an opening having a straight and internally threaded inner wall surface for screwing onto one end of the externally threaded bolt 2I. The bolt 2I is provided at each end surface with a plurality of angularly equally spaced radial splits 41I. Two spike dowels 31I are separately provided for use with the bolt 2I. When the two ends of the bolt 2I are separately fully screwed to bottoms of the openings of the two sleeves 1I with the two spike dowels 31I separately located at convergent center holes of the radial splits 41I at two end surfaces of the bolt 2I, the two ends of the bolt 2I are forced to expand open and therefore firmly locate in the openings of the two sleeves 1I.

FIG. 11B is an exploded sectional view of a steel bar joint according to a tenth embodiment of the present invention. The steel bar joint of this tenth embodiment is structurally and functionally similar to the steel bar joint shown in FIGS. 11 and 11A, except that the two separate spike dowels 32I are omitted and the opening of each sleeve 1I is provided at an inner bottom center with an integrally formed spike dowel 32I.

What is claimed is:

1. An improvement of steel bar joint for connecting two steel bars end to end, comprising at least an internally threaded sleeve and at least an externally threaded bolt, said bolt having at least one free end, on a surface of which a plurality of angularly equally spaced radial splits are provided; and at least a spike dowel having a pointed bar being located in at least an inner bottom of said at least one sleeve to align said pointed bar with a convergent center hole of said radial splits at said at least one free end surface of said bolt; whereby when said at least one bolt is connected to said at least one sleeve by fully screwing the at least one free end thereof to the at least one inner bottom of said sleeve, said pointed bar of said at least one spike dowel is forced into said convergent center hole of said radial splits at said at least one free end surface of said at least one bolt and thereby expands open said at least one free end of said at least one bolt for external threads of said bolt to tightly engage with internal threads of said at least one sleeve and thereby ensures an enhanced connection stability of said steel bar joint.

2. The improvement of steel bar joint as claimed in claim 1, wherein said at least one sleeve is in the number of two for separately fixedly connected at rear ends to two opposite ends of two steel bars to be serially connected to each other, and said at least one bolt is in the number of one and having two free ends separately screwed to inner bottoms of said two sleeves.

3. The improvement of steel bar joint as claimed in claim 1, wherein said at least one bolt is in the number of two for separately fixedly connected at rear ends to two opposite ends of two steel bars to be serially connected to each other, and said at least one sleeve is in the number of one and having two ends separately screwed onto free ends of said two bolts.

4. The improvement of steel bar joint as claimed in claim 1, wherein both said at least one bolt and said at least one sleeve are in the number of one for separately fixedly connected at rear ends to two opposite ends of two steel bars to be serially connected to each other, and the free end of said bolt being adapted to fully screw to the inner bottom of said sleeve.

5. The improvement of steel bar joint as claimed in claim 1, wherein said at least one sleeve has a straight inner wall surface on which internal threads are provided, and said at least one bolt has a straight outer wall surface on which external threads are provided to mesh with said internal threads of said at least one sleeve.

6. The improvement of steel bar joint as claimed in claim 1, wherein said at least one sleeve has a backward tapered inner wall surface on which internal threads are provided, and said at least one bolt has a forward tapered outer wall surface on which external threads are provided to mesh with said internal threads of said at least one sleeve.

7. The improvement of steel bar joint as claimed in claim 1, wherein said at least one spike dowel is a separate member from said at least one sleeve and includes a flat seat, from a center at one side thereof said pointed bar of said spike dowel extends.

8. The improvement of steel bar joint as claimed in claim 1, wherein said at least one spike dowel is an integral part of said at least one sleeve to forward project said pointed bar from a center of said inner bottom of said at least one sleeve.
